(19) United States
(12) Patent Application Publication
(10) Pub. No.: US 2015/0364140 A1
(43) Pub. Date: Dec. 17, 2015

(54) Portable Electronic Equipment and Method of Operating a User Interface

(71) Applicant: Sony Corporation, Tokyo (JP)

(72) Inventor: Ola Thörn, Limhamn (SE)

(21) Appl. No.: 14/304,055

(22) Filed: Jun. 13, 2014

(51) Int. Cl. G10L 15/26; G06F 3/01; G06F 17/24

(52) U.S. Cl. CPC G10L 15/26; G06F 17/24; G06F 3/013

(57) ABSTRACT

A portable electronic equipment comprises a speech to text conversion module configured to generate a text by performing a speech to text conversion. A gaze tracking device is configured to track an eye gaze direction of a user on a display on which the text is displayed. The portable electronic equipment is configured to selectively activate a text editing function based on the tracked eye gaze direction.

### FIELD OF THE INVENTION

Embodiments of the invention relate to a portable electronic equipment and to a method of operating a user interface of a portable electronic equipment. Embodiments of the invention relate in particular to portable electronic equipments which are configured to perform a speech to text conversion to generate a text.

### BACKGROUND OF THE INVENTION

Many portable electronic devices have a user interface which allows text to be input and edited. Techniques of inputting text include keyboard based techniques, stenography based techniques, or speech to text conversion. Keyboard based input may be slow on conventional keyboards. Keyboard layouts such as the Dvorak simplified keyboard (DSK) may mitigate such problems to a certain extent.

Speech to text conversion relies on the processing of input signals to convert spoken or uttered speech into text. One advantage of speech to text conversion is that it is convenient for the user and allows text to be input in an intuitive way. Although the accuracy of speech recognition has improved, utterances may still be misinterpreted by a speech to text conversion machine. Adding special characters such as punctuation marks may be cumbersome, because many users are not trained to including special characters in dictation. Misinterpreted words may also propagate throughout the text when the speech to text conversion machine uses word context to increase accuracy.

While such shortcomings may be mitigated by editing the text using a keyboard once the speech to text conversion has been completed, such a correction process may be slow and may reduce the convenience of using the user interface. For illustration, a cursor may have to be positioned manually via the keyboard before the text editing may be performed.

### SUMMARY

There is a need in the art for a portable electronic equipment and a method of operating a user interface of a portable electronic equipment which mitigate at least some of these shortcomings. There is in particular a need in the art for a portable electronic equipment and a method of operating a user interface of a portable electronic equipment in which text generated by speech to text conversion can be edited more easily and in a more intuitive way.

According to embodiments of the invention, an electronic equipment combines speech to text conversion for generating text from spoken utterances with eye gaze control of a text editing function. The electronic equipment according to embodiments may be configured such that a text editing function may be activated selectively for a portion of the generated text by eye gaze control. The electronic equipment according to embodiments may be configured such that a speech to text conversion module may automatically determine which portions of a text are likely to be edited. The eye gaze based control may allow a text editing function to be selectively activated for the portions of the text which the speech to text conversion module identifies as candidates for a text editing.

A gaze tracking device of the portable electronic equipment which is configured to track a eye gaze direction may comprise a video camera which is arranged to face the user when the portable electronic equipment is in use. An example for such a video camera is the low-resolution video camera of a portable telephone. By using the video camera for gaze tracking, no separate, dedicated gaze tracking sensor must be provided.

A portable electronic equipment according to an embodiment comprises a speech to text conversion module configured to generate a text by performing a speech to text conversion. The portable electronic equipment comprises a gaze tracking device configured to track an eye gaze direction of a user on a display on which the text is displayed. The portable electronic equipment is configured to selectively activate a text editing function based on the tracked eye gaze direction.

The portable electronic equipment may be configured to assign a numerical value to each one of several portions of the text based on the speech to text conversion. The portable electronic equipment may be configured to selectively activate the text editing function for editing a portion of the text selected from the several portions. The portion for which the text editing function is activated may be determined based on the assigned numerical values and based on the tracked eye gaze direction.

The numerical value may represent a probability assigned to a word and/or interword space.

The numerical value may represent a probability, determined based on the text to speech conversion, that editing of the text is required at the respective location. The numerical value may be used to define sizes of activation areas for eye gaze based activation of gaze tracking.

The portable electronic equipment may be configured to adapt the way in which the tracked eye gaze direction affects the text editing function in dependence on the numerical values assigned to words and/or interword spaces.

The numerical values may indicate a probability that a word has been misinterpreted and/or that a special character is to be inserted at an interword space.

The portable electronic equipment may be configured to use the numerical values to define at least one activation area on the display which is associated with at least one of a word or an interword space. The text editing function may be selectively activated for correcting a word or for inserting a special character at an interword space based on the eye gaze direction. A dwell time of the eye gaze direction on an activation area may trigger execution of the text editing function for correcting the respective word or adding a special character at the respective interword space.

The portable electronic equipment may be configured to determine the portion for which the text editing function is activated based on the assigned numerical values and based on a heat map for the eye gaze direction. The fast changes in eye gaze direction may be processed by generating the heat map and associating the heat map with regions on the display for which the numerical values indicate that a word may have been misinterpreted by the speech to text conversion module and/or that a special character is likely to be inserted.

The portable electronic equipment may be configured to assign the numerical value to respectively each one of several words of the text based on a speech to text conversion accuracy. The speech to text conversion accuracy may represent a likelihood that a spoken utterance has been misinterpreted by the speech to text conversion. The speech to text conversion module may be configured to determine the likelihood based on whether the spoken utterance can be uniquely assigned to a word included in a dictionary of the portable electronic equipment. The speech to text conversion module may be configured to determine the likelihood based on whether there are plural candidate words in the dictionary to which the spoken utterance could be assigned.

The portable electronic equipment may be configured such that a dwell time of the monitored eye gaze direction on an activation area associated with a word triggers the text editing function for editing the word. The portable electronic equipment may be configured to set a size of the activation area in dependence on the speech to text conversion accuracy. A word for which the speech to text conversion module determines that a misinterpretation is more likely may be assigned a greater activation area. A word for which the speech to text conversion module determines that the recognition quality is good may be assigned no activation area at all or only a small activation area for activating the text editing function by eye gaze.

The word to which an activation area may be a sequence of characters which does not correspond to a word included in a dictionary of the portable electronic equipment. The word may be a sequence of characters which is a fragment of a dictionary word of the portable electronic equipment.

The portable electronic equipment may be configured such that the text editing function allows the user to perform the text editing by eye gaze control. The text editing function may offer several alternative words from which the user may select one word by using his eye gaze direction. The correct word may be selected in an intuitive way by simply gazing at it.

The portable electronic equipment may be configured such that the activation area for activating the text editing function for a word covers the pixels on which the word is displayed on the display and an area surrounding the pixels on which the word is displayed on the display. The activation area may be dimensioned in accordance with a resolution of the eye gaze tracking device. The text editing function may be reliably activated even with an eye gaze tracking device which uses a low resolution camera, e.g. a video camera of a mobile communication terminal, because the size of the activation area may be adjusted to the resolution of the camera.

Alternatively or additionally to assigning numerical values to words based on the likelihood of a misinterpretation, the portable electronic equipment may be configured to assign the numerical value to respectively each one of several interword spaces.

The numerical value may indicate at which ones of the several interword spaces a punctuation mark is expected to be located. An interword space for which the speech to text conversion module expects that a punctuation mark should be inserted may be assigned a different numerical value than another interword space for which the speech to text conversion machine expects that no punctuation mark should be inserted.

The portable electronic equipment may be configured such that a dwell time of the monitored eye gaze direction on an activation area associated with an interword space triggers the text editing function for editing the interword space.

The portable electronic equipment is configured to set a size of the activation area in dependence on a likelihood that a special character is to be inserted at the interword space.

The portable electronic equipment may be configured to set the size of the activation area such that the size of the activation area is larger than the interword space.

The gaze tracking device may comprise a camera. The camera may be a video camera of a terminal of a cellular communication network.

The speech to text conversion module may be coupled to the camera and may be configured to generate the text by speech to text conversion based on images captured by the camera. The camera may thereby be used for both the speech to text conversion which uses lip movements as input and the eye gaze based activation of the text editing function.

Alternatively or additionally, the portable electronic equipment may comprise a microphone and/or an Electromyography (EMG) sensor configured to capture speech signals. The speech to text conversion module may be coupled to the microphone and/or the EMG sensor and may be configured to generate the text by speech to text conversion of the captured speech signals.

The portable electronic equipment may be configured to selectively activate the gaze tracking device in response to an error detection performed by the speech to text conversion module. The gaze tracking device may be triggered to track the eye gaze direction when the speech to text conversion module detects a pre-determined number of misinterpretations or of words which do not correspond to dictionary words.

The portable electronic equipment may be configured to activate the gaze tracking device independently of an error detection performed by the speech to text conversion module.

The portable electronic equipment may be configured to determine based on the tracked eye gaze direction whether the text editing function is activated for inserting only one word or whether the text editing function is activated for inserting a plurality of words.

The portable electronic equipment may comprise a wireless interface configured for communication with a cellular communication network.

The portable electronic equipment may be a terminal of a cellular communication network.

The portable electronic equipment may be a handheld device. The speech to text conversion module and the eye gaze tracking device may both be integrated in a housing of the handheld device.

The portable electronic equipment may comprise a handheld device which includes the speech to text conversion module and a wearable device, in particular a head mounted device, which comprises the gaze tracking device.

A method of operating a user interface of a portable electronic equipment comprises performing, by a speech to text conversion module, a speech to text conversion to generate a text. The method comprises tracking, by a gaze tracking device, an eye gaze direction of a user on a display on which the text is displayed. The method comprises selectively activating a text editing function based on the tracked eye gaze direction to allow the user to edit the text.

The method may further comprise assigning a numerical value to each one of several portions of the text based on the speech to text conversion. The text editing function may be selectively activated for editing a portion which is determined based on the assigned numerical values and based on the tracked eye gaze direction.

The numerical value may be assigned to respectively each one of several words of the text based on a speech to text conversion accuracy.

The method may further comprise setting a size of an activation area associated with a word in dependence on a speech to text conversion accuracy. The text editing function may be selectively activated for editing the word based on a dwell time of the tracked eye gaze direction on the activation area.

Alternatively or additionally, the numerical value may be assigned to respectively each one of several interword spaces of the text.

The method may further comprise setting a size of an activation area associated with an interword space in dependence on a likelihood that a special character is to be inserted at the interword space. The text editing function may be selectively activated for editing the word based on a dwell time of the tracked eye gaze direction on the activation area.

The method may comprise selectively activating the gaze tracking device in response to an error detection performed by the speech to text conversion module. The gaze tracking device may be triggered to track the eye gaze direction when the speech to text conversion module detects a pre-determined number of misinterpretations or of words which do not correspond to dictionary words.

The method may comprise activating the gaze tracking device independently of an error detection performed by the speech to text conversion module.

The method may comprise determining, based on the tracked eye gaze direction, whether the text editing function is activated for inserting only one word or whether the text editing function is activated for inserting a plurality of words.

The method may be automatically performed by a portable electronic equipment according to an embodiment.

Portable electronic equipments and methods of operating a user interface of a portable electronic equipment according to exemplary embodiments may be used for activating a text editing function and, optionally, controlling the text editing function after activation by eye gaze direction to correct text generated by speech to text conversion.

It is to be understood that the features mentioned above and features yet to be explained below can be used not only in the respective combinations indicated, but also in other combinations or in isolation, without departing from the scope of the present invention. Features of the above-mentioned aspects and embodiments may be combined with each other in other embodiments.

### BRIEF DESCRIPTION OF THE DRAWINGS

The foregoing and additional features and advantages of the invention will become apparent from the following detailed description when read in conjunction with the accompanying drawings, in which like reference numerals refer to like elements.

FIG. 1 is a front view of a portable electronic equipment according to an embodiment.

FIG. 2 is a schematic block diagram of the portable electronic equipment of FIG. 1.

FIG. 3 is a flow chart of a method according to an embodiment.

FIG. 4 is a view illustrating operation of a portable electronic equipment according to an embodiment.

FIG. 5 is a view illustrating operation of a portable electronic equipment according to an embodiment.

FIG. 6 is a flow chart of a method according to an embodiment.

FIG. 7 illustrates activation areas defined by the portable electronic equipment according to an embodiment.

FIG. 8 illustrates an eye gaze direction determined by the portable electronic equipment, from which the heat map is computed.

FIG. 9 is a schematic block diagram of a portable electronic equipment according to another embodiment.

FIG. 10 is a schematic block diagram of a portable electronic equipment according to another embodiment.

FIG. 11 is a view of a portable electronic equipment according to another embodiment.

FIG. 12 is a functional block diagram representation of a portable electronic equipment according to an embodiment.

FIG. 13 is a flow chart of a method performed by a portable electronic equipment according to an embodiment.

FIG. 14 is a flow chart of a method performed by a portable electronic equipment according to an embodiment.

FIG. 15 is a view illustrating operation of a portable electronic equipment according to an embodiment.

FIG. 16 is a view illustrating operation of a portable electronic equipment according to an embodiment.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations, and elements illustrated in the drawings are not necessarily shown to scale. Rather, the various elements are represented such that their function and general purpose become apparent to a person skilled in the art. Any connection or coupling between functional blocks, devices, components or other physical or functional units shown in the drawings or described herein may also be implemented by an indirect connection or coupling.

The features of the various embodiments may be combined with each other, unless specifically noted otherwise.

A portable electronic equipment and methods of operating a user interface of a portable electronic equipment will be described. The portable electronic equipment comprises a speech to text conversion module. The speech to text conversion module may determine a textual representation of a spoken utterance. The speech to text conversion module may generate a text which comprises a plurality of words, which do not necessarily need to be dictionary words of the portable electronic equipment.

In order to allow a user to edit text generated by speech to text conversion in an intuitive way, the portable electronic equipment includes a gaze tracking device. A text editing function may be activated by eye gaze. For illustration, the gaze tracking device may be configured to determine the dwell time of a user's eye gaze on an activation area. When the dwell time exceeds a threshold, this triggers execution of the text editing function. The text editing function may allow a user to select an alternative spelling for a word provided by the speech to text conversion module if the user's eye gaze direction dwells on the respective word. The text editing function may alternatively or additionally allow a user to enter a special character at an interword space if the if the user's eye gaze direction dwells on the respective interword space.

The gaze tracking device may be a video camera comprising an image sensor. The gaze tracking device may alternatively or additionally comprise a sensor which is sensitive in the infrared spectral range to detect the eye gaze direction using infrared probe beams. The portable electronic equipment may be configured to determine an eye gaze direction by determining a gaze point on a display of the portable electronic equipment, for example.

The portable electronic equipment is configured to combine speech to text conversion which provides an intuitive text inputting method with eye gaze activation of a text editing function. The portable electronic equipment may use an output of the speech to text conversion module to determine whether eye gaze based activation of the text editing function shall be available for editing a word and/or an interword space. For illustration, when the speech to text conversion module determines that a spoken utterance has been converted into a textual representation of a word with a low risk of misinterpretation, the portable electronic equipment may not allow the user to activate the text editing function for this particular word based on eye gaze. Alternatively, the dwell time which triggers activation of the text editing function for editing a word may be longer if the text recognition accuracy is determined to be good.

As will be explained in more detail, the portable electronic equipments and methods of embodiments allow text editing to be performed under eye gaze control. The text editing function may be activated by eye gaze while the speech to text conversion is still in progress and/or after the speech to text conversion has been completed.

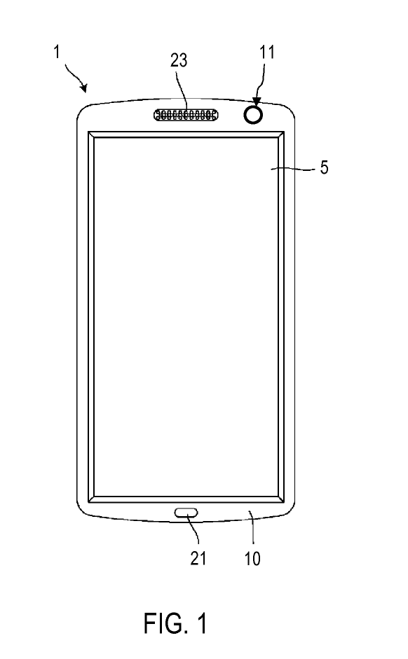

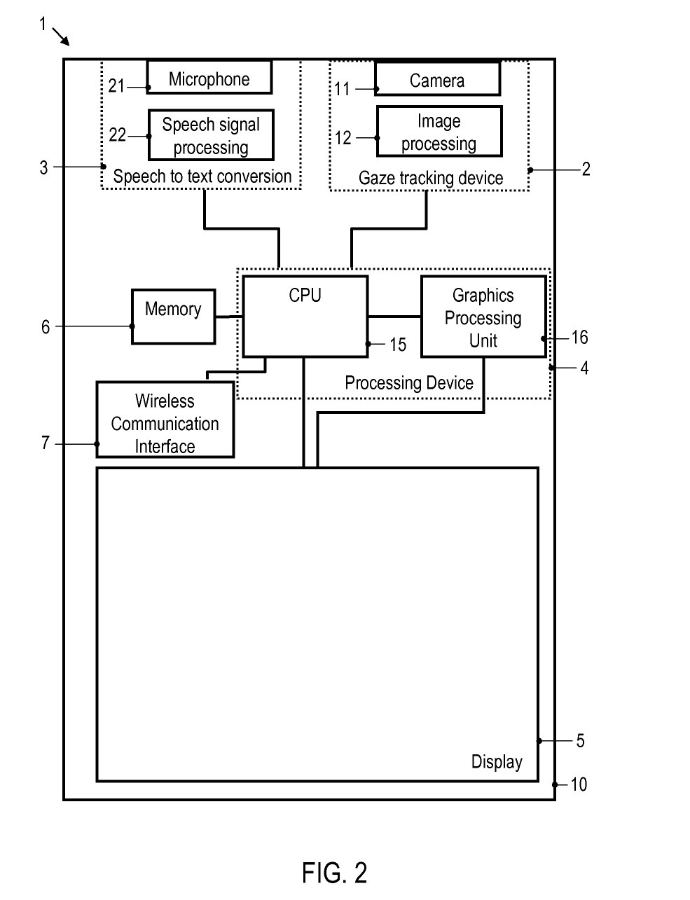

FIG. 1 is a front view of a portable electronic equipment 1 and FIG. 2 is a schematic block diagram representation of the portable electronic equipment 1.

The portable electronic equipment 1 comprises a gaze tracking device 2. The gaze tracking device 2 may comprise a camera 11. The camera 11 may be configured as a video camera facing the user. The eye position in the images captured by the camera 11 may be processed by an image processing module 12 to determine a gaze direction. The portable electronic equipment 1 comprises a speech to text conversion module 3. The speech to text conversion module 3 may comprise a microphone 21 and a speech signal processing circuit 22. The microphone 21 may be the microphone of the portable electronic equipment 1 used for voice communication over a cellular communication network, for example. Other sensors may be used to capture speech signals which serve as input signals for speech to text conversion. For illustration, the speech to text conversion module 3 may comprise an Electromyography (EMG) sensor and/or a camera for capturing speech signals which are converted into textual representations of words. The portable electronic equipment 1 comprises a display 5 on which the text generated by the speech to text conversion module 3 from speech signals is displayed.

The portable electronic equipment 1 comprises a processing device 4 coupled to the gaze tracking device 2. The processing device 4 may be one processor or may include plural processors, such as a main processor 15 and a graphics processing unit 16. The processing device 4 may have other configurations and may be formed by one or several integrated circuits such as microprocessors, microcontrollers, processors, controllers, or application specific integrated circuits.

The processing device 4 may perform processing and control operations. The processing device 4 may be configured to execute a text editing function which allows the user to edit text generated by speech to text conversion of spoken utterances. The processing device 4 may determine, based on a tracked eye gaze motion, at which word and/or interword space the user gazes. The processing device 4 may activate the text editing function for editing the word and/or interword space for the word or interword space on which the user's eye gaze dwells. The text editing function may be allow a user to select from among several candidate words and/or candidate characters which may be selected depending on which word or interword space the user is gazing at.

The portable electronic equipment 1 may comprise a non-volatile memory 6 or other storage device in which a dictionary and/or grammar rules may be stored. The processing device 4 may be configured to select words from the dictionary and/or special characters when the text editing function is activated by the user's eye gaze.

The portable electronic equipment 1 may be operative as a portable communication device, e.g. a cellular telephone, a personal digital assistant, or similar. The portable electronic equipment 1 may include components for voice communication, which may include the microphone 21, a speaker 23, and the wireless communication interface 7 for communication with a wireless communication network. The portable electronic equipment 1 may be configured as a handheld device. The various components of the portable electronic equipment 1 may be integrated in a housing 10.

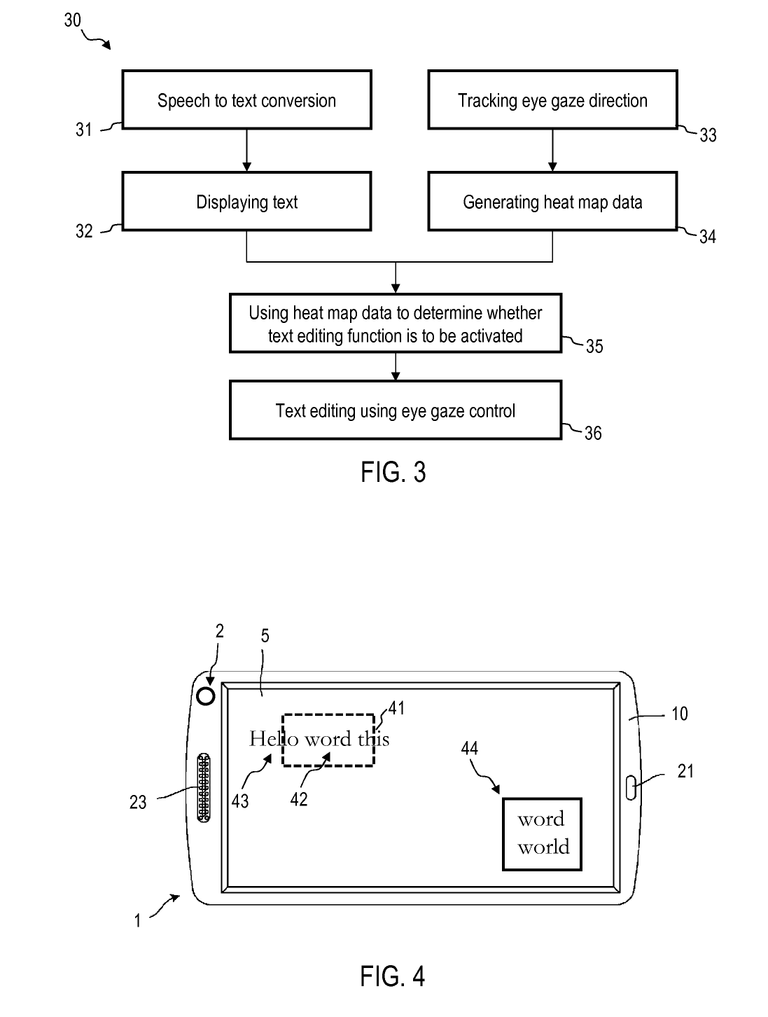

The operation of the portable electronic equipment 1 will be described in more detail with reference to FIGS. 3 to 12 below.

FIG. 3 is a flow chart of a method 30 according to an embodiment. The method 30 may be performed by the portable electronic equipment 1.

At 31, a speech to text conversion is performed to generate a text from speech. The speech to text conversion may use a speech signal captured by a microphone and/or EMG sensor as an input signal. The speech to text conversion may use images captured by a camera as an input signal and may analyze lip movements for determining a textual representation of spoken words. The speech to text conversion may be operative to generate the text even for low-volume or non-audible speech, e.g. by using an output signal of an EMG sensor, of a throat microphone or of a camera as input signal.

At 32, the text generated by the speech to text conversion is displayed on a display of the portable electronic equipment. The text may be updated as new words are recognized.

At 33, gaze tracking is performed to track an eye gaze direction of one eye or both eyes of a user. A gaze tracking device may be started when the speech to text conversion starts or when the portable electronic equipment is started. The gaze tracking device may be started when potential errors are detected in the speech to text conversion. A convergence point of the eye gaze directions of both eyes may be determined. The eye gaze direction may be tracked in a time interval to obtain statistics on preferred gaze directions which the user has been looking at more frequently than other gaze directions. The eye gaze direction may be recorded for a plurality of times in a time interval. The eye gaze direction may be recorded by a gaze tracking device which can fulfill other functions in the portable electronic equipment. For illustration, the gaze tracking device may be a video camera arranged on the same side of the housing 10 as a display 5 so as to point towards the user in operation of the portable electronic equipment 1, as may be desired for video calls.

At 34, heat map data are computed from the information collected by the gaze tracking device. The heat map data may define, for several points or several regions, the fraction of time in the time interval for which the user has been gazing at the respective point or region. A convolution between the points on an eye gaze trajectory and a non-constant spread function f(x, y) may be computed to determine the heat map data, where f(x, y) may be a Gaussian curve, a Lorentz function, or another non-constant function which takes into account that the gaze tracking device has a limited resolution. The heat map data may alternatively be computed by computing, for each one of several pixels on the display 5, the fraction of time for which the user has been gazing at the respective pixel when taking into account the probability spreading caused by the resolution of the gaze tracking device, for example. Various other techniques from the field of gaze tracking may be used to compute the heat map data.

The gaze tracking at 33 and generation of heat map data at 34 may be performed in parallel with the speech to text conversion as illustrated in FIG. 3. In other embodiments, the gaze tracking at 33 may be performed after completion of the speech to text conversion to allow the text editing function to be selectively activated for individual words or interword spaces of a text.

At 35, the heat map data may be used to determine whether the text editing function is to be activated. The heat map data may be used to determine for which word(s) and/or interword space(s) the text editing function is to be activated. The selection of the passage(s) of the text for which the text editing function is to be activated may be performed by the user's eye gaze. Information provided by the speech to text conversion module may be used to define different criteria for activating the text editing function by eye gaze. For illustration, the size of an activation area on which the user's eye gaze must be directed for activating the text editing function for a word or interword space may be set depending on a score which quantifies the likelihood of misinterpretation for the particular word and/or a score which quantifies the likelihood that a punctuation mark or other special character is to be inserted at a particular interword space. Alternatively or additionally, a threshold for a dwell time at which the text editing function is triggered may be set depending on the score which quantifies the likelihood of misinterpretation for the particular word and/or the score which quantifies the likelihood that a punctuation mark or other special character is to be inserted at a particular interword space.

At 36, text editing may be performed. The text editing function may use the user's eye gaze as input. For illustration, several words may be displayed by the text editing function from which the user may select one word for editing the text by his eye gaze.

Several special characters may be displayed by the text editing function from which the user may select one special character for editing the text by his eye gaze.

While heat map data may be generated at 34, as described with reference to FIG. 3, the portable electronic equipment according to embodiments does not need to generate heat map data. For illustration, the dwell time on an activation area may be determined without computing heat map data. The text editing function may be triggered based on the eye gaze direction, possibly in combination with dwell times for different gaze points, without computing heat map data.

The portable electronic equipment and method according to an embodiment allows the text editing function to be called up in a simple and intuitive way based on the eye gaze direction. Information on the text provided by the speech to text conversion module may be used to determine onto which areas on the display 5 the user needs to gaze and/or which dwell times must be met in order to trigger execution of the text editing function.

The activation area at which the user must gaze for the text editing function to be triggered may be set to have a larger size if no word matching the spoken utterance has been found in a dictionary and/or if the speech to text module determines that it is likely to have misinterpreted the word. The activation area at which the user must gaze for the text editing function to be triggered may be set to have a smaller size if a word matching the spoken utterance has been found in a dictionary and/or if the speech to text module determines that it is likely to have correctly interpreted the word.

Alternatively or additionally, the dwell time for which the user must gaze an activation area for the text editing function to be triggered may be set to be shorter if no word matching the spoken utterance has been found in a dictionary and/or if the speech to text module determines that it is likely to have misinterpreted the word. The dwell time for which the user must gaze at the activation area for the text editing function to be triggered may be set to have a smaller size if a word matching the spoken utterance has been found in a dictionary and/or if the speech to text module determines that it is likely to have correctly interpreted the word.

A score may be used to quantify whether the speech to text module determines that it is likely to have misinterpreted the word. As used herein, the term “score” refers to a numerical value which is a quantitative indication for a likelihood, e.g. for a likelihood of a spoken utterance being correctly converted into a word or for a likelihood that a special character has to be inserted at an interword space. The size of the activation area and/or the dwell time which triggers execution of the text editing function may respectively be set depending on the score.

The score which may be assigned to each one of several portions of the text, such as words and/or interword spaces, may be used by the portable electronic equipment to adapt how it responds to the tracked eye gaze direction. For illustration, a saliency map may be generated which indicates potentially relevant areas on the display for the text editing function may need to be activated, as determined based on an output of the speech to text conversion module. The response of the portable electronic equipment may be adjusted accordingly. For illustration, areas in which the speech to text conversion module detects possible errors may be made to be more responsive to an activation of the text editing function based on eye gaze.

FIG. 4 is a view illustrating the display 5 of the portable electronic equipment 1. A text is generated by speech to text conversion and is displayed on the display 5. When the portable electronic equipment 1 determines that a word 42 may need to be edited, e.g. because there is an ambiguity in assigning the correct word to the received speech signal, the portable electronic equipment 1 may allow the user to activate a text editing function for editing the word by an eye gaze directed onto the word.

The portable electronic equipment 1 may define an activation area 41 which includes pixels on which the word 42 is displayed. The activation area 41 may be larger than the region in which the word 42 is displayed. This facilitates a selection of the activation area 41 by eye gaze even when the eye gaze direction cannot be determined with high resolution.

The size of the activation area 41 at which the user must gaze may be set in dependence on a score assigned to the word 42. The score may indicate how reliable the speech to text conversion is. For illustration, there may be an ambiguity in converting a speech signal to either one of “word” or “world”. The dwell time for which the user's gaze must be directed on the activation area 41 to trigger the activation of the text editing function may also be set depending on the score assigned to the word 42.

The text editing function may also be responsive to the eye gaze direction. For illustration, to edit the word 42, various text strings 44 may be displayed by the text editing function from which the user may select one by using his eye gaze. The selected word may replace the word 42.

An activation of the text editing function by eye gaze may be limited to certain portions of the text only, e.g. to the words for which the speech to text module may have misinterpreted the speech signal. For other words, e.g. for a word 43, the user may still activate the text editing function by manual input actions, for example.

While the activation area 41 is schematically shown by broken lines in FIG. 4, the boundary of the activation area may be displayed, but will generally not be displayed on the display 5.

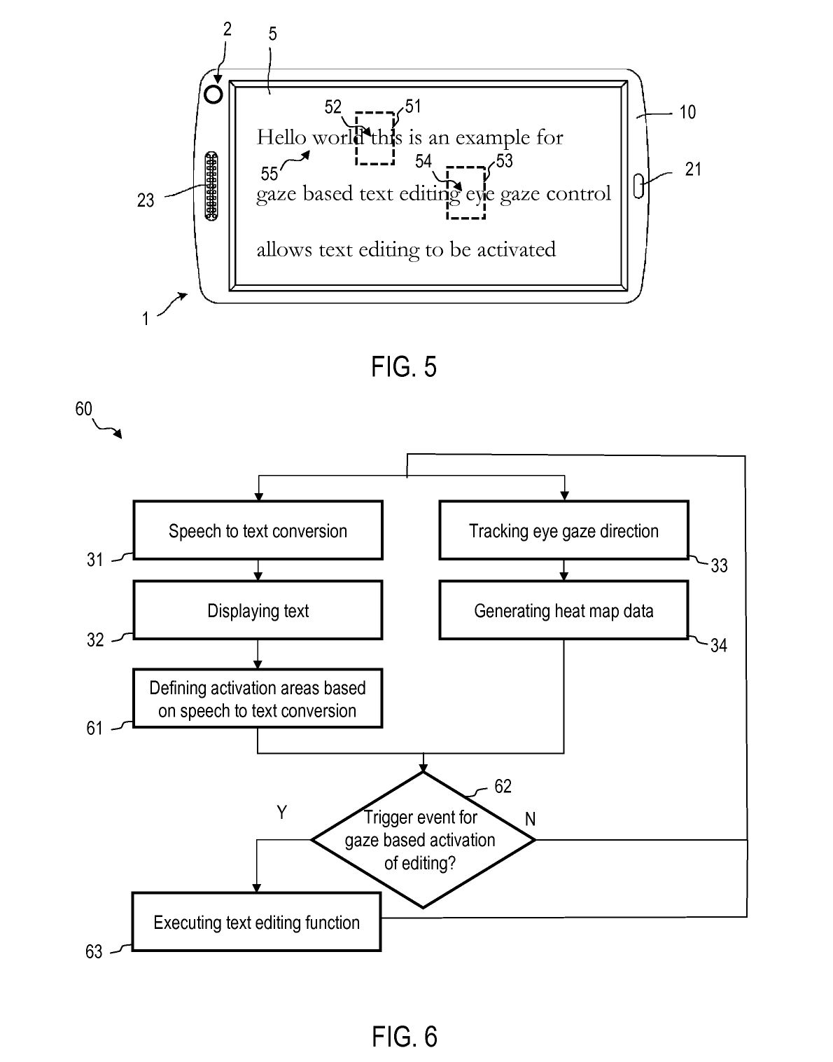

Alternatively or additionally to editing words, the eye gaze based activation of a text editing function may also be used for allowing a user to insert special characters, as illustrated in FIG. 5.

FIG. 5 is a view illustrating the display 5 of the portable electronic equipment 1. A text is generated by speech to text conversion and is displayed on the display 5. When the portable electronic equipment 1 determines that an interword space 52, 54 may need to be edited, e.g. because grammar rules or a modulation of the speech signal indicate that a punctuation mark or other special character may need to be added there, the portable electronic equipment 1 may allow the user to activate a text editing function for editing the interword space 52, 54 by an eye gaze directed onto the interword space 52, 54.

The portable electronic equipment 1 may define an activation area 51, 53 which includes pixels which form the interword space 52, 54 is displayed. The activation area 51, 53 may be larger than the actual interword space and may extend to at least partially cover words adjacent the respective interword space. This facilitates a selection of the activation area 51, 53 by eye gaze even when the eye gaze direction cannot be determined with high resolution.

The size of the activation area 51, 53 at which the user must gaze may be set in dependence on a score assigned to the associated interword space 52, 54. The score may indicate how likely it is, in accordance with grammar rules and/or a modulation of the speech signal, that a special character needs to be added to the interword space. For illustration, the end of a sentence at interword space 54 may be automatically determined based on grammar rules. The dwell time for which the user's gaze must be directed on the activation area 51, 3 to trigger the activation of the text editing function may also be set depending on the score assigned to the respective interword space 52, 53.

The text editing function may also be responsive to the eye gaze direction. For illustration, to edit the interword space 52, 54, various special characters may be displayed by the text editing function from which the user may select one by using his eye gaze. The selected special character may be inserted into the interword space.

An activation of the text editing function by eye gaze may be limited to certain portions of the text only, e.g. to the interword spaces for which it is determined that a punctuation mark or other special character will likely have to be added there. For other interword spaces, e.g. for an interword space 55, the user may still activate the text editing function by manual input actions, for example.

While the activation area 51, 53 is schematically shown by broken lines in FIG. 5, the boundary of the activation area may be displayed, but will generally not be displayed on the display 5.

FIG. 6 is a flow chart of a method 60 according to an embodiment. The method 60 may be performed by the portable electronic equipment according to an embodiment.

In the method 60, activation areas on the display may be defined at 61. The activation areas may be defined in dependence on the speech to text conversion. Activation areas may be defined to be located at words and/or interword spaces where text editing is likely to be required. A score may be assigned to words, with the score indicating a likelihood that the speech to text conversion did not identify the correct word and that text editing may therefore be required. A score may be assigned to interword spaced to indicate a likelihood that a special character must be added at the respective interword space. The size of the activation areas may respectively be set depending on the score. Alternatively or additionally, a dwell time for which a user's eye gaze must be directed onto the activation area associated with a word or interword space for activating the text editing function may be set in dependence on the score.

At 62, it is determined whether a trigger event for activating the text editing function occurs. The text editing function may be activated when the user's eye gaze is directed onto the activation area associated with a word or interword space for at least a dwell time. The dwell time which triggers the execution of the text editing function may be set in dependence on the score associated with the word or interword space. The heat map data may be used to determine whether the eye gaze dwell time is long enough to trigger execution of the text editing function. If the trigger event is not detected, the method may return to steps 31, 33.

At 63, in response to detecting the trigger event at 62, the text editing function may be executed. The text editing function may allow the user to edit the text by eye gaze control.

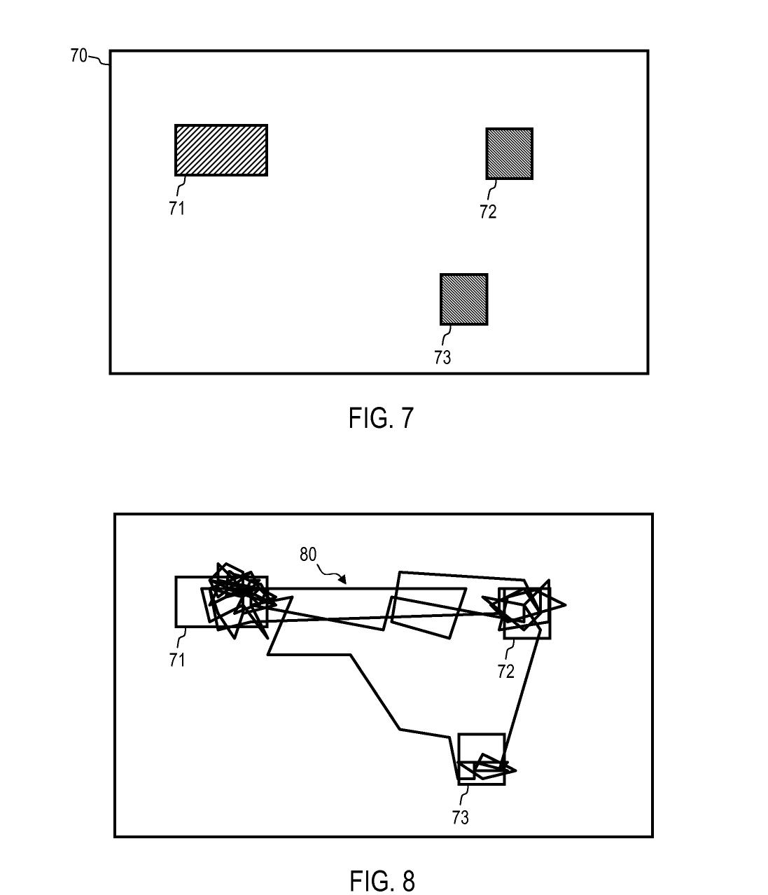

FIG. 7 shows a user interface 70 which may be the display of the portable electronic equipment. The portable electronic equipment uses the output of the speech to text conversion module to define activation areas 71-73 at which the user may direct the eye gaze to activate a text editing functions for a word or interword space. The word or interword space for which the text editing function may be activated by eye gaze may be located below the associated activation area 71-73. The size of one or several of the activation areas 71-73 may be set in dependence on a score of the word or interword space. The gaze dwell time after which the text editing function is triggered may be set in dependence on a score of the word or interword space.

The text editing function may perform different functions for different activation areas 71-73. For an activation area associated with a word, e.g. activation area 71, the user may be allowed to edit the word by selecting from among other candidate words and/or by using textual character input. For an activation area associated with an interword space, e.g. activation areas 72, 73, the text editing function may allow the user to insert a punctuation mark or other special character.

FIG. 8 shows a path 80 of the user's eye gaze direction on the display. The user's eye gaze direction may move rapidly between words at which the user intends to perform a text editing operation and/or interword spaces at which the user intends to perform a text editing operation. In the illustrated example, the gaze dwell time is greatest in the activation area 71. The text editing function may be activated to enable a user to edit the word or interword space associated with the activation area 71.

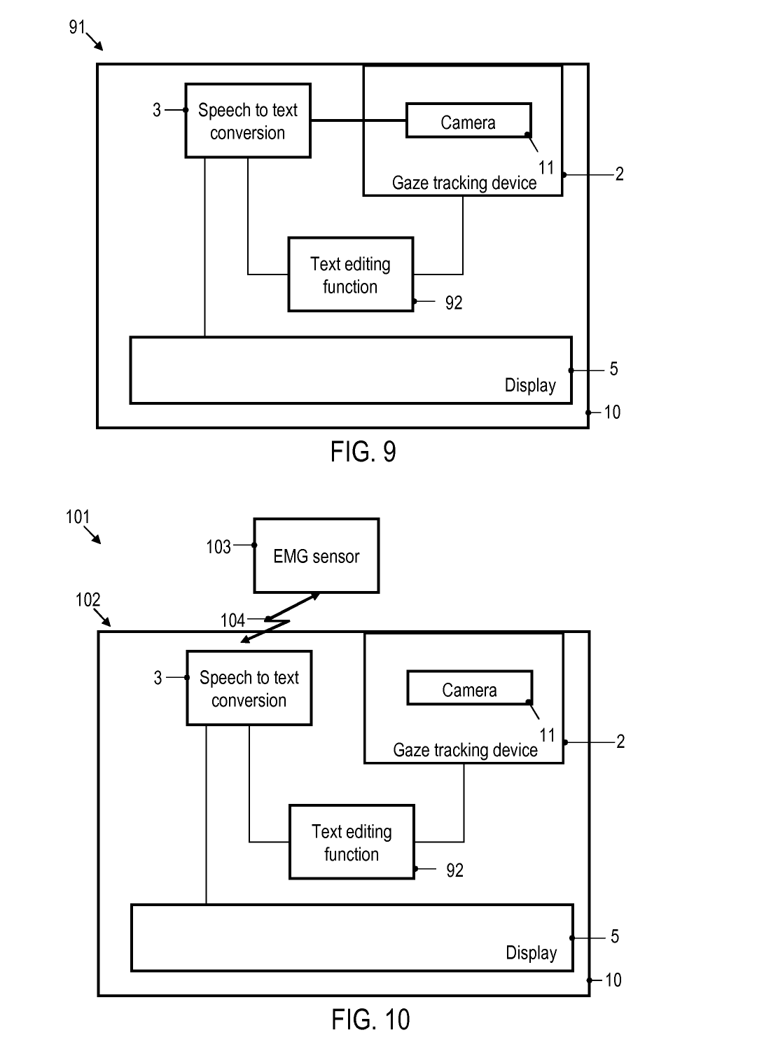

Various modifications of the portable electronic equipment may be implemented in further embodiments, as will be explained in more detail with reference to FIG. 9 to FIG. 11.

FIG. 9 is a block diagram representation of a portable electronic equipment 91 according to an embodiment. The speech to text conversion module 3 is operative to convert speech to text. The speech to text conversion module 3 is connected to the camera 11 and is configured to analyze lip movement in the images captured by the camera 11. Thereby, speech to text conversion may be performed. Both the speech to text conversion module 3 and the gaze tracking device 2 may process the images captured by the camera 11. The speech to text conversion module 3 may identify and analyze lip movement to perform automatic lip reading. The gaze tracking device 2 may analyze at least one eye of the user shown in the images captured by the camera to track an eye gaze direction.

The text editing function 92 can be selectively activated based on the eye gaze direction of the user. The configuration of the text editing function 92, e.g. the portions of the text for which the text editing function 92 may be activated by eye gaze, may be set in dependence on an output of the speech to text conversion module 3. Sizes of areas at which the user may look to activate the text editing function for editing a word or interword space may be adjusted based on a score for the respective word or interword space. The score may quantify the quality of the speech to text conversion and/or the likelihood for insertion of a special character. Alternatively or additionally, the gaze dwell time required for activation of the text editing function may be adjusted in dependence on the score.

The portable electronic equipment 91 may comprise a microphone or other sensor in addition to the camera 11 as an input to the speech to text conversion module. In other embodiments, the speech to text conversion module 91 is not coupled to a microphone.

Additional features and operation of the portable electronic equipment 91 may be implemented as described with reference to FIG. 1 to FIG. 8 above.

FIG. 10 is a block diagram representation of a portable electronic equipment 101 according to an embodiment. The portable electronic equipment 101 comprises an EMG sensor 103. The speech to text conversion module 3 processes speech signals provided by the EMG sensor 103. The EMG sensor 103 may be connected to the speech to text conversion module via a data connection 104, which may be implemented as a wireless communication link or a wired communication link. The EMG sensor 103 may be provided separately from a housing 102 in which the speech to text conversion module and the gaze tracking device are installed.

Additional features and operation of the portable electronic equipment 91 may be implemented as described with reference to FIG. 1 to FIG. 9 above.

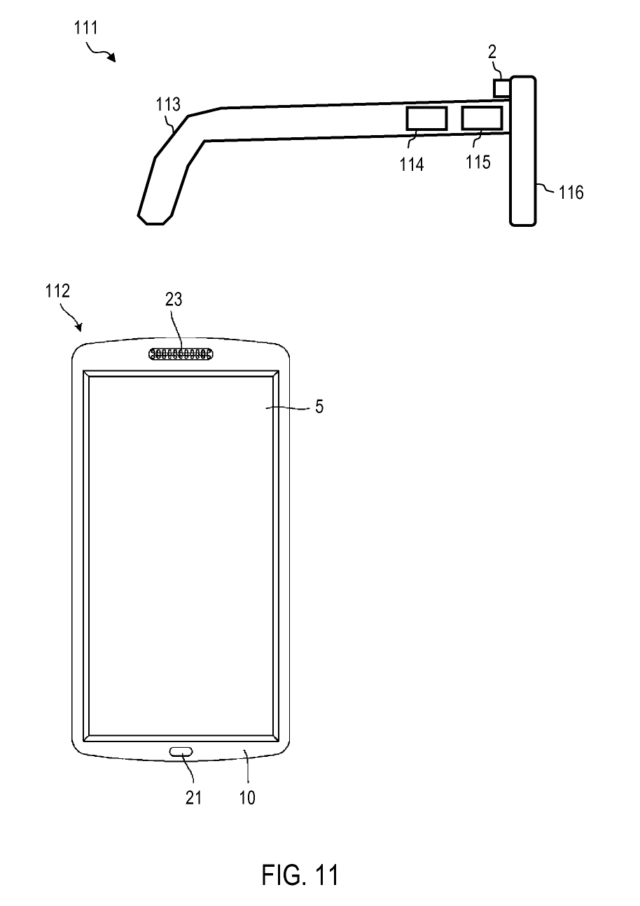

FIG. 11 is a view of a portable electronic equipment 111 according to an embodiment. The portable electronic equipment 111 comprises a handheld device 112 and a wearable device 113 separate from the handheld device 112. The speech to text conversion module and the gaze tracking device may be provided in separate devices in the portable electronic equipment 111. The speech to text conversion module may be installed in the handheld device 112 and may be operative as explained with reference to FIG. 1 to FIG. 9 above.

Text generated by the speech to text conversion module may be displayed at the wearable device 113. The wearable device 113 may in particular be a head mounted device. The wearable device 113 may comprise a display surface at which the text generated by speech to text conversion may be output to the user. The wearable device 113 may receive the text from the speech to text conversion module over an interface 114, which may be a wireless interface. A processing device 115 of the wearable device 113 may selectively activate a text editing function which allows the user to edit the text displayed at the wearable device 113.

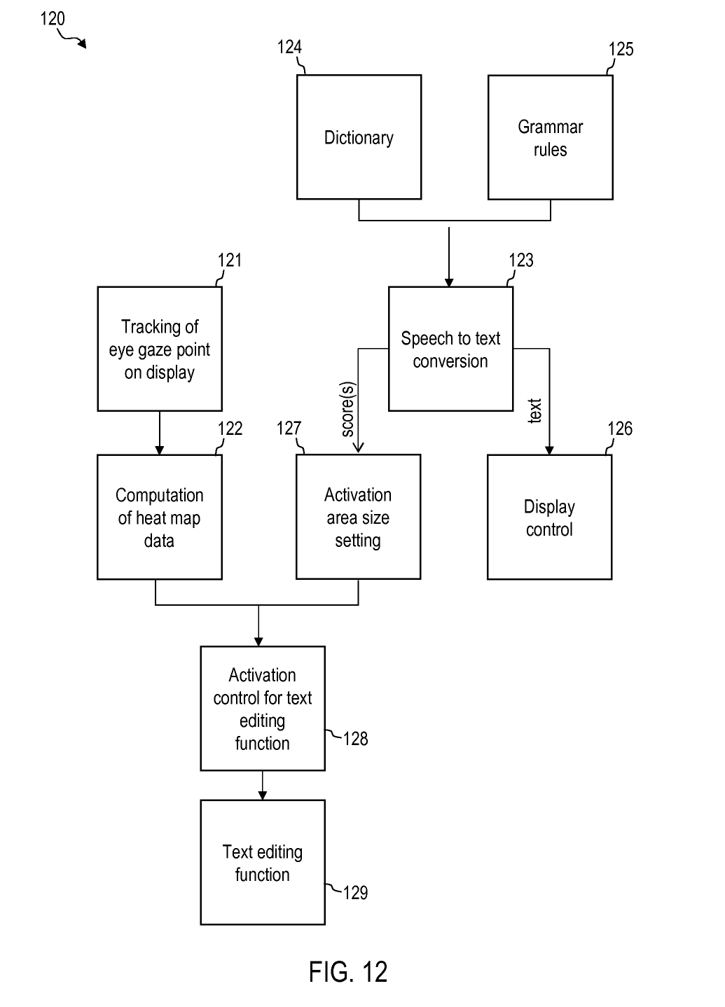

FIG. 12 is a block diagram representation 120 of a portable electronic equipment according to an embodiment. While separate functional blocks are shown in FIG. 12 for greater clarity, several functional blocks may be combined into one physical unit.

The portable electronic equipment has a tracking module 121 for tracking an eye gaze direction on a display. The portable electronic equipment may have an evaluation module 122 for processing the tracked eye gaze direction, e.g. by computing a heat map.

The portable electronic equipment has a speech to text conversion module 123. The speech to text conversion module 123 is operative to convert a speech signal representing a spoken utterance into a textual representation. The speech signal may represent a sound signal captured by a microphone, an electrical signal captured by an EMG sensor, and/or visual data captured by an image sensor. The speech to text conversion module 123 may access a dictionary 124 and/or grammar rules 125 for converting the speech signal into the text. The speech to text conversion module 123 may also be operative to determine a score for words and/or interword spaces of the text. The score may quantify a likelihood for a text editing function to take place. The score may indicate whether a speech signal could not be uniquely assigned to one dictionary word in the dictionary 124. The score for a word may indicate whether the speech to text conversion identified alternative dictionary words which could also be associated with the speech signal. The score for an interword space may indicate a probability for insertion of a punctuation mark or other special character.

The portable electronic equipment may comprise a display control 126. The display control 126 may control a display to output the text generated by the speech to text conversion module 123.

The portable electronic equipment may comprise a setting module 127 for setting sizes and positions of activation areas at which the user must gaze to activate the text editing function. The setting module 127 may optionally set the sizes of the activation areas in dependence on the score associated with a word or interword space, respectively.

The portable electronic equipment may comprise an activation module 128 which controls activation of a text editing function. The activation module 128 may be triggered to activate the text editing function based on the tracked eye gaze direction. The activation module 128 may activate the text editing function for editing a word or interword space if the heat map data indicates that a dwell time of the user's gaze exceeds a threshold. The threshold may optionally depend on the score assigned to the respective word or interword space.

The portable electronic equipment comprises a text editing function 129 which allows a user to edit the text generated by the speech to text conversion module 123. The text editing function 129 may be selectively activated by the activation module 128. The eye gaze direction of the user may be used control activation of the text editing function 129 for at least some portions of the text. The text editing function 129 may be responsive to the eye gaze direction and may allow a user to select from among several possible edit actions by eye gaze direction based control.

In any one of the portable electronic equipments and methods, the gaze tracking device may be started in a conventional manner, e.g. by a dedicated user input or automatically at start up.

In any one of the portable electronic equipments and methods, the gaze tracking device may be started to track the eye gaze direction selectively only in response to an output of the speech to text conversion module. For illustration, the gaze tracking device may be triggered to operate when a pre-defined number of errors are identified in the speech to text conversion. The errors may be words which cannot be assigned to a dictionary word and/or words for which there is an ambiguity which requires disambiguation. The pre-defined number of errors may be one error. The pre-defined number of errors may be greater than one, so that eye gaze based control of the text editing function is started selectively only when several errors may need to be corrected.

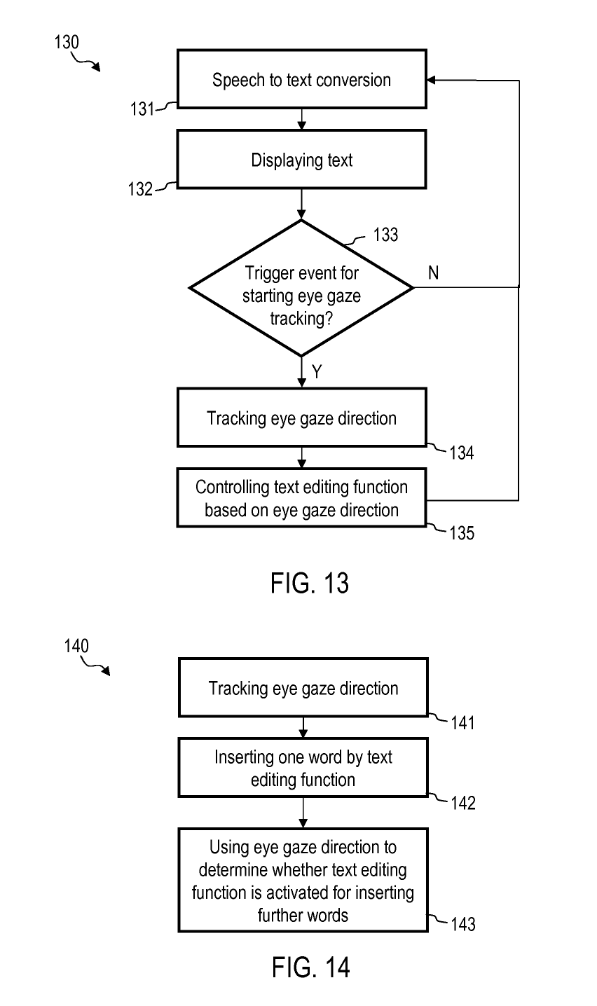

FIG. 13 is a flow chart of a method 130 according to an embodiment. The method 130 may be performed by the portable electronic equipment according to an embodiment.

In the method 130, speech to text conversion is performed at 131. The generated text is displayed at 132. These steps may be implemented in accordance with any one of the techniques described with reference to FIG. 1 to FIG. 12 above.

At 133, it is determined whether a trigger event for activating the gaze tracking device is fulfilled. The trigger event may depend on an output of the speech to text conversion. The trigger event may depend on a number of potential errors and/or misinterpretations identified by the speech to text conversion module. If the trigger event is not detected, the speech to text conversion is continued at 131.

At 134, if the trigger event is detected at 133, the gaze tracking device is activated to track the eye gaze direction. At 135, the text editing function may be selectively activated and controlled based on the tracked eye gaze direction. The tracking of the eye gaze direction and the control of the text editing function based on the tracked eye gaze direction may be implemented in accordance with any one of the techniques described with reference to FIG. 1 to FIG. 12 above. The speech to text conversion may be continued at 131.

Controlling the activation of the text editing function may include determining whether only one or more than one word is to be inserted into the text. This decision on whether one or more than one word is to be inserted into the text may be controlled based on the eye gaze direction in any one of the various embodiments, as will be described with reference to FIG. 14 to FIG. 16.

FIG. 14 is a flow chart of a method 140 according to an embodiment. The method 140 may be performed by the portable electronic equipment according to an embodiment. In the method 140, the eye gaze direction may be used to determine whether only one word or more than one word are inserted into the text, with the determination being controlled by the eye gaze direction.

At 141, a gaze tracking device tracks the eye gaze direction.

At 142, one word is inserted into the text generated by speech to text conversion using a text editing function. The text editing function may be activated based on the eye gaze direction or may even be activated by touch for inserting this word.

At 143, the eye gaze direction is used to determine whether at least one further word is to be inserted. For illustration, the user may continue to insert words at a selected location in the text by directing the eye gaze onto certain regions of the display. The user may continue to insert words at the selected location by continuing his dictation when his eye gaze remains generally directed towards the location at which the words are to be inserted. Because the gaze point may wander over the display with a high speed, the fact that the gaze point leaves the region where words are inserted by continued dictation does not necessarily mean that inserting more than one word at the selected location is terminated.

By using the eye gaze direction for controlling whether the text editing function is activated for inserting only one word or for inserting more than one word, Midas problems may be mitigated.

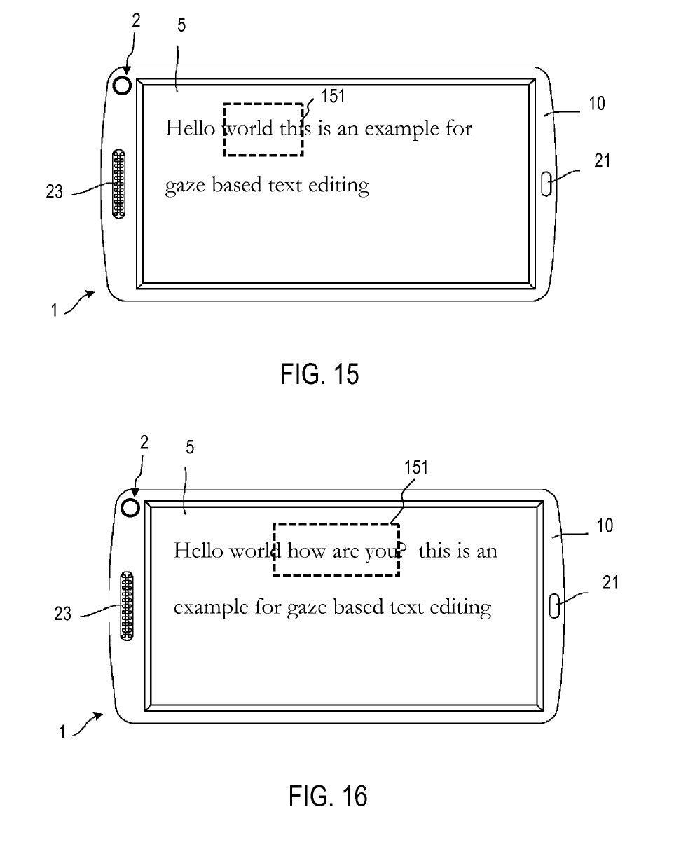

FIG. 15 and FIG. 16 are views illustrating operation of the portable electronic equipment according to an embodiment in which the eye gaze direction may be used for controlling whether the text editing function is activated for inserting only one word or for inserting more than one word. The text editing function may be activated for a region 151 on the display. The activation may be done by eye gaze, as described above, or even by touch. The user may dictate one word. If the dwell time of the user's eye gaze on the region 151 meets a pre-defined criterion, the user may continue to dictate words for insertion at the selected location in the text. The user's eye gaze does not need to be permanently fixed onto the region 151. The criterion used for determining whether the user may continue to insert further words may allow the user's eye gaze direction to leave the region 151. The size and/or position of the region 151 may also be adapted as the user continues to insert more words at the same location in the original text.

While portable electronic equipments and methods of controlling portable electronic equipments have been described with reference to the drawings, modifications and alterations may be implemented in further embodiments. For illustration rather than limitation, while exemplary implementations for gaze tracking devices have been described, other or additional sensor componentry may be used. For illustration, a dedicated sensor may be provided for tracking the eye gaze direction. The dedicated sensor may be an infrared sensor which detects reflections of infrared light to establish the eye gaze direction. The gaze tracking device may, but does not need to be a sensor which is sensitive in the visible spectral range.

For further illustration, while the portable electronic equipment may be a hand-held device or a head-mounted device, the portable electronic equipment may also have other configurations.

Examples for portable electronic equipments which may be configured as described herein include, but are not limited to, a mobile phone, a cordless phone, a personal digital assistant (PDA), a head mounted display, and the like.

Although the invention has been shown and described with respect to certain preferred embodiments, equivalents and modifications will occur to others skilled in the art upon the reading and understanding of the specification. The present invention includes all such equivalents and modifications, and is limited only by the scope of the following claims.

What is claimed is:

1. A portable electronic equipment, comprising:
a speech to text conversion module configured to generate a text by performing a speech to text conversion;
a gaze tracking device configured to track an eye gaze direction of a user on a display on which the text is displayed; and
a text editing function configured to allow the user to edit the text;
the portable electronic equipment being configured to selectively activate the text editing function based on the tracked eye gaze direction.

2. The portable electronic equipment of claim 1,
wherein the portable electronic equipment is configured to assign a numerical value to each one of several portions of the text based on the speech to text conversion and to selectively activate the text editing function for editing a portion of the text selected from the several portions, the portion being determined based on the assigned numerical values and based on the tracked eye gaze direction.

3. The portable electronic equipment of claim 2,
wherein the portable electronic equipment is configured to determine the portion for which the text editing function is activated based on the assigned numerical values and based on a heat map for the eye gaze direction.

4. The portable electronic equipment of claim 2,
wherein the portable electronic equipment is configured to assign the numerical value to respectively each one of several words of the text based on a speech to text conversion accuracy.

5. The portable electronic equipment of claim 4,
wherein the portable electronic equipment is configured such that a dwell time of the monitored eye gaze direction on an activation area associated with a word triggers the text editing function for editing the word,
wherein the portable electronic equipment is configured to set a size of the activation area in dependence on the speech to text conversion accuracy.

6. The portable electronic equipment of claim 2,
wherein the portable electronic equipment is configured to assign the numerical value to respectively each one of several interword spaces.

7. The portable electronic equipment of claim 6,
wherein the numerical value indicates at which ones of the several interword spaces a punctuation mark is expected to be located.

8. The portable electronic equipment of claim 6,
wherein the portable electronic equipment is configured such that a dwell time of the monitored eye gaze direction on an activation area associated with an interword space triggers the text editing function for editing the interword space,
wherein the portable electronic equipment is configured to set a size of the activation area in dependence on a likelihood that a special character is to be inserted at the interword space.

9. The portable electronic equipment of claim 8,
wherein the portable electronic equipment is configured to set the size of the activation area such that the size of the activation area is larger than the interword space.

10. The portable electronic equipment of claim 1,
wherein the gaze tracking device comprises a camera.

11. The portable electronic equipment of claim 10,
wherein the speech to text conversion module is coupled to the camera and is configured to generate the text by speech to text conversion based on images captured by the camera.

12. The portable electronic equipment of claim 1, further comprising:
a microphone and/or an Electromyography sensor configured to capture speech signals,
wherein the speech to text conversion module is configured to generate the text by speech to text conversion of the captured speech signals.

13. The portable electronic equipment of claim 1,
wherein the portable electronic equipment is configured to selectively activate the gaze tracking device in response to an error detection performed by the speech to text conversion module.

14. The portable electronic equipment of claim 1,
wherein the portable electronic equipment is configured to determine based on the tracked eye gaze direction whether the text editing function is activated for inserting only one word or whether the text editing function is activated for inserting a plurality of words.

15. A method of operating a user interface of a portable electronic equipment, the method comprising:
performing, by a speech to text conversion module, a speech to text conversion to generate a text;
tracking, by a gaze tracking device, an eye gaze direction of a user on a display on which the text is displayed; and
selectively activating a text editing function based on the tracked eye gaze direction to allow the user to edit the text.

16. The method of claim 15, further comprising:
assigning a numerical value to each one of several portions of the text based on the speech to text conversion,
wherein the text editing function is selectively activated for editing a portion which is determined based on the assigned numerical values and based on the tracked eye gaze direction.

17. The method of claim 16,
wherein the numerical value is assigned to respectively each one of several words of the text based on a speech to text conversion accuracy.

18. The method of claim 17, further comprising:
setting a size of an activation area associated with a word in dependence on a speech to text conversion accuracy,
wherein the text editing function is selectively activated for editing the word based on a dwell time of the tracked eye gaze direction on the activation area.

19. The method of claim 16,
wherein the numerical value is assigned to respectively each one of several interword spaces of the text.

20. The method of claim 19, further comprising:
setting a size of an activation area associated with an interword space in dependence on a likelihood that a special character is to be inserted at the interword space,
wherein the text editing function is selectively activated for editing the word based on a dwell time of the tracked eye gaze direction on the activation area.
